(19) United States
(12) Patent Application Publication
(10) Pub. No.: US 2007/0211000 A1
(43) Pub. Date: Sep. 13, 2007

(54) IMAGE PROCESSING APPARATUS AND IMAGE DISPLAY METHOD

(75) Inventors: Goh Itoh, Tokyo (JP); Kazuyasu Ohwaki, Kawasaki-Shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/683,757

(22) Filed: Mar. 8, 2007

(30) Foreign Application Priority Data
Mar. 8, 2006 (JP) 2006-063049

(51) Int. Cl. G09G 3/32

(52) U.S. Cl. 345/83

(57) ABSTRACT

There is provided with an apparatus for image processing for displaying an image on a dot matrix type display device having a plurality of display elements each emitting single light, including: an image input unit configured to input an input image having pixels each including one or more color components; an image feature extraction unit configured to extract a feature of the input image; a filter processor configured to generate K subfield images by performing a filter process using K filters for the input image of one frame; a display order setting unit configured to set a display order of the K subfield images based on the feature of the input image; and an image display control unit configured to display the K subfield images in accordance with the display order on the display device in one frame period of the input image.

### CROSS-REFERENCE TO RELATED APPLICATIONS

This application is based upon and claims the benefit of priority from the prior Japanese Patent Applications No. 2006-63049 filed on Mar. 8, 2006, the entire contents of which are incorporated herein by reference.

### BACKGROUND OF THE INVENTION

1. Field of the Invention

The present invention relates to an image processing apparatus and an image display method suitably used in a display system in which input image signals having a higher space resolution than the space resolution of a dot matrix type display device is inputted.

2. Related Art

There is a large size LED (Light-Emitting Diode) display device in which a plurality of LED capable of emitting the light of any of three primary colors of red, green and blue are arranged like a dot matrix. That is, each pixel of this display device has an LED capable of emitting the light of any one color of red, green and blue. However, since the element size per LED is large, it is difficult to make the higher finesses even with the large size display device, and the space resolution is not very high. Therefore, the down-sampling is required to display input image signals having a higher resolution than the display device, but since the flickering due to folding remarkably degrades the image quality, it is common to pass the input image signals through a low pass filter as a pre-filter. As a matter of course, if the high components are reduced too much by the low pass filter, the image becomes faded to make the visibility worse.

On the other hand, the LED display device usually displays the image by refreshing the same image multiple times to keep the brightness, because the response characteristic of LED elements is very fast (almost 0 ms). For example, the frame frequency of input image signals is usually 60 Hz, but the field frequency of the LED display device is as high as 1000 Hz. In this way, the LED display device is characterized in that the resolution is low but the field frequency is high.

To make the LED display device higher resolution, the following method is adopted for improvements in Japanese Patent No. 3396215, for example. First of all, each lamp (display element) of the display device and the pixel (one pixel having three color components of red, green and blue) on the input image are associated one-to-one. And the image is displayed by dividing one frame period into periods of four fields (hereinafter referred to as subfields).

In the first subfield period, each lamp is driven based on the value of component of the same color as the lamp among the pixel values of the pixel corresponding to its lamp. In the second subfield period, each lamp is driven based on the value of component of the same color as the lamp among the pixel values of the pixel to the right of the pixel corresponding to its lamp. In the third subfield period, each lamp is driven based on the value of component of the same color as the lamp among the pixel values of the pixel in the lower right of the pixel corresponding to its lamp. In the fourth subfield period, each lamp is driven based on the value of component of the same color as the lamp among the pixel values of the pixel under the pixel corresponding to its lamp.

That is, the method as described in the above patent displays the information of the input image in time series at high speed by changing a way of thinning for every subfield period, thereby attempting to display all the information of the input image.

With the method as described in the above patent, the image is displayed for each subfield period by the same way of thinning, regardless of the contents of the input image. From the experiments by the present inventors using the method as described in the above patent, the present inventors found that the image quality of moving image was greatly varied depending on the contents of the input image.

### SUMMARY OF THE INVENTION

According to an aspect of the present invention, there is provided with an apparatus for image processing for displaying an image on a dot matrix type display device having a plurality of display elements each emitting single light, comprising:

an image input unit configured to input an input image having pixels each including one or more color components;

an image feature extraction unit configured to extract a feature of the input image;

a filter processor configured to generate K subfield images by performing a filter process using K filters for the input image of one frame;

a display order setting unit configured to set a display order of the K subfield images based on the feature of the input image; and

an image display control unit configured to display the K subfield images in accordance with the display order on the display device in one frame period of the input image.

According to an aspect of the present invention, there is provided with an image display method for displaying an image on a dot matrix type display device having a plurality of display elements each emitting single light, comprising:

inputting an input image having pixels each including one or more color components;

extracting a feature of the input image;

generating K subfield images by performing a filter process using K filters for the input image of one frame;

setting a display order of the K subfield images based on the feature of the input image; and

displaying the K subfield images in accordance with the display order on the display device in one frame period of the input image.

### BRIEF DESCRIPTION OF THE DRAWINGS

FIG. 1 is a diagram showing the configuration of an image display system according to a first embodiment;

FIGS. 2A and 2B are views showing an input image and a display panel for use in the first embodiment, respectively;

FIG. 3A to 3D are views for explaining examples of a time varying filter process according to the first embodiment;

FIG. 4 is a view for explaining the influence of the time varying filter process on the image quality in the first embodiment;

FIG. 5 is a view for explaining the influence of the time varying filter process on the image quality in the first embodiment;

FIG. 6 is a view for explaining the influence of the time varying filter process on the image quality in the first embodiment;

FIG. 7 is a view for explaining the influence of the time varying filter process on the image quality in the first embodiment;

FIG. 8 is a view for explaining the influence of the time varying filter process on the image quality in the first embodiment;

FIG. 9 is a table showing a shift scheme and a moving direction appropriate to the shift scheme;

FIG. 10 is a flowchart showing a filter condition decision method of the time varying filter in the first embodiment;

FIG. 11 is a flowchart showing another filter condition decision method of the time varying filter in the first embodiment;

FIG. 12 is a flowchart showing a further filter condition decision method of the time varying filter in the first embodiment;

FIG. 13 is a view for explaining a filter process in a subfield image generation unit according to a second embodiment;

FIG. 14 is a view showing the examples of the filter coefficients of the filter for use in the filter processor according to the second embodiment;

FIG. 15 is a view showing the examples of the filter coefficients of another filter for use in the filter processor according to the second embodiment;

FIG. 16 is a view showing the examples of the filter coefficients of a further filter for use in the filter processor according to the second embodiment;

FIG. 17 is a view showing an example of a process in a filter processor according to a third embodiment; and

FIG. 18 is a view showing another example of the process in the filter processor according to the third embodiment.

### DETAILED DESCRIPTION OF THE INVENTION

The preferred embodiments of the present invention will be described below in detail with reference to the drawings in connection with an LED (Light-Emitting Diode) display device that is a representative example of a dot matrix display device. The embodiments of the invention are based on generating the subfield images by making different filter processes for an input image in each subfield period in which one frame period is divided into K, and displaying each generated subfield image at a rate of K times the frame frequency(frame rate). In the following, performing different filter processes in the time direction (for every subfield period) is called a time varying filter process, and the filters for use in this time varying filter process is called a time varying filter. The display device subject to this invention is not limited to the LED display device, but the invention is also effective to all the display devices of which the space resolution is lower than that of the input image but the field frequency is higher than that of the input image.

### First Embodiment

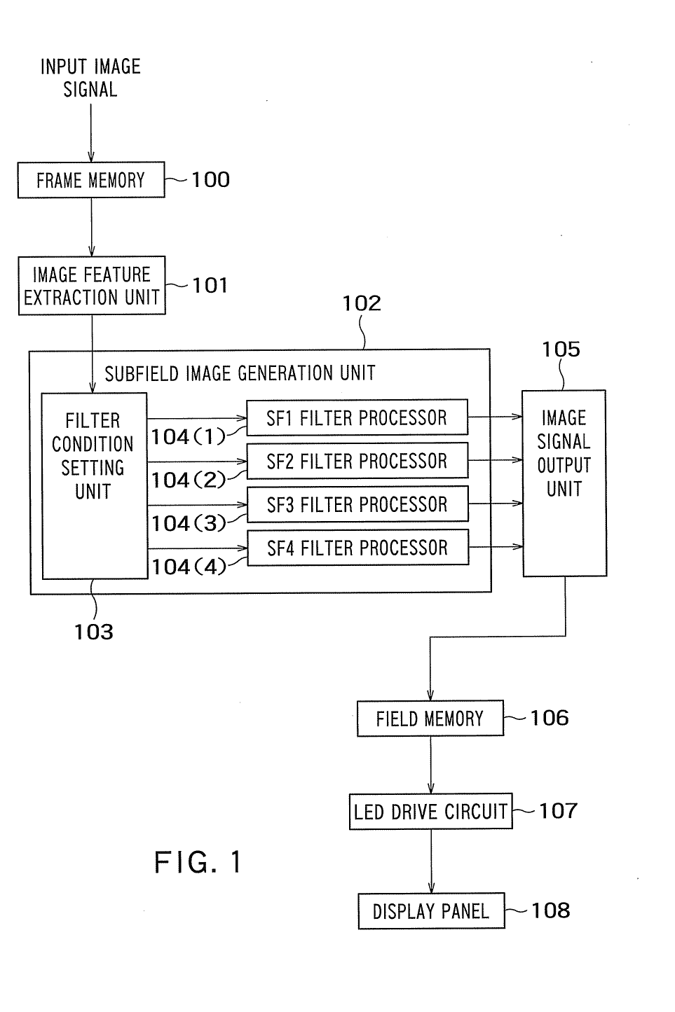

FIG. 1 is a block diagram of an image processing system according to the invention.

Input image signals are stored in a frame memory 100, and then sent to an image feature extraction unit 101. The frame memory 100 includes an image input unit which inputs an input image having pixels each including one or more color components.

The image feature extraction unit 101 acquires the image features such as a movement direction, a speed and a space frequency of an object within the contents, from one or more frame images. Hence, a plurality of frame memories may be provided.

A filter condition setting unit (display order setting unit) 103 of a subfield image generation unit 102 decides the first to fourth filters for use in the first to fourth subfield periods in which one frame period is divided into plural number (four here), based on the image features extracted by the image feature extraction unit 101, and passes the first to fourth filters to the filter processors for subfields 1 to 4 (SF1 to SF4 filter processors) 104(1) to 104(4). More particularly, the filter condition setting unit (display order setting unit) 103 orders the four filters (set a display order of images generated by the four filters) based on the image features extracted by the image feature extraction unit 101, and passes the first to fourth filters arranged in the display order to the SF1 to SF4 filter processors 104(1) to 104(4). The SF1 to SF4 filter processors 104(1) to 104(4) perform the filter processes for the input frame image in accordance with the first to fourth filters passed by the filter condition setting unit 103 to generate the first to fourth subfield images (time varying filter process). Herein, the subfield image is one of the images into which one frame image is divided in the time direction, whereby a sum of subfield images in the time direction corresponds to one frame image. The first to fourth subfield images generated by the SF1 to SF4 filter processors 104(1) to 104(4) are sent to an image signal output unit 105.

The image signal output unit 105 sends the first to fourth subfield images received from the subfield image generation unit 102 to a field memory 106. An LED drive circuit 107 reads the first to fourth subfield images corresponding to one frame from the field memory 106, and displays these subfield images in the order of first to fourth on a display panel (dot matrix display device) 108 in one frame period. That is, the subfield images are displayed at a rate of frame frequency×number of subfields (the number of subfields is four in this embodiment). The image signal output unit 105, the field memory 106 and the LED drive circuit 107 correspond to an image display control unit, for example.

In this embodiment, since one frame period is divided into four subfield periods, the four SF filter processors are provided, but if the SF1 to SF4 filter processes may be performed in time series (not required to be performed in parallel), only one SF filter process can be provided.

The characteristics of this embodiment are the image feature extraction unit 101 and the subfield image generation unit 102. Before they are explained in detail, the influence of the filter conditions on the moving image quality in the time varying filter process will be firstly described.

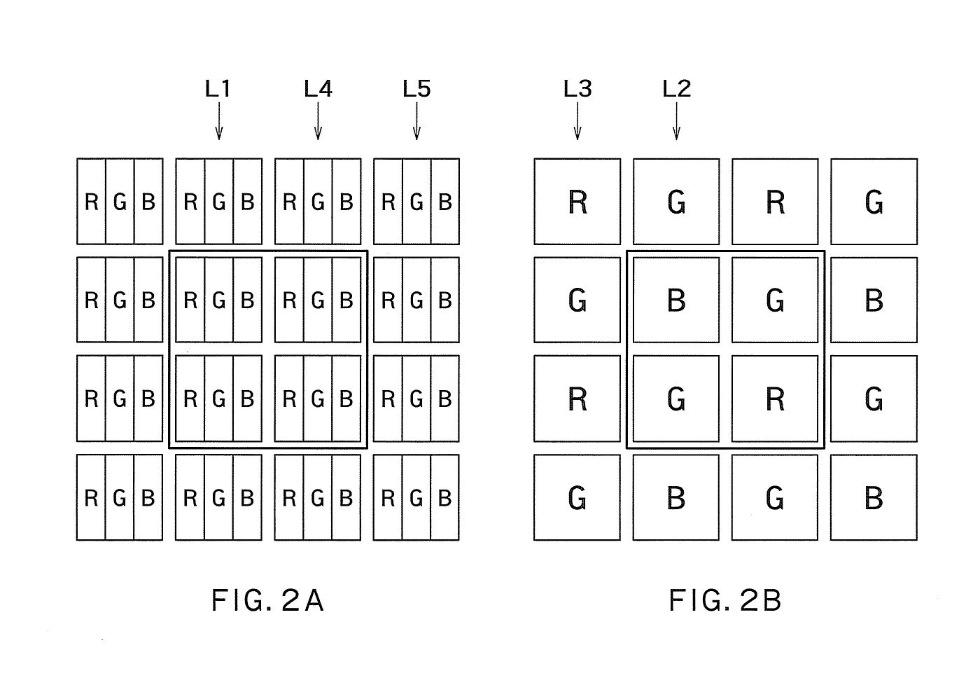

To simplify the explanation, it is supposed that the input image is 4×4 pixels, and each pixel has image information for red (R), green (G) and blue (B), as shown in FIG. 2A. On the other hand, it is supposed that the display panel has 4×4 display elements (light emitting elements) as shown in FIG. 2B, and one pixel (one set of RGB) of the input image corresponds to one display element on the display panel. One display element can emit only the light of any one color of RGB, and consists of any one of red LED, green LED and blue LED. Hence, in this example, taking the 2×2 pixels of the input image (see a portion enclosed by the rectangle), the 2×2 pixels are converted into an organization of LED dots of one R, two Gs and one B. In this way, the space resolution is reduced into one-quarter for R and B, and half for G, whereby it is required that the sub-sampling for every color is performed in displaying the image. Generally, the input image is passed through a low pass filter as a preprocessing not to cause a folding.

A general form of the time varying filter process involves creating each subfield image by changing the spatial position (phase) to be filtered for the input image (original image). For example, in a case where one frame period ( 1/60 seconds) is divided into four subfield periods, and the subfield image is changed at every 1/240 seconds in displaying the image, the four subfield images are created in which the position of the input image to be filtered is different for every subfield period. In the following, changing the spatial position to be filtered is called a filter shift, and a method for changing the spatial position of the filter is called a shift scheme of the filter.

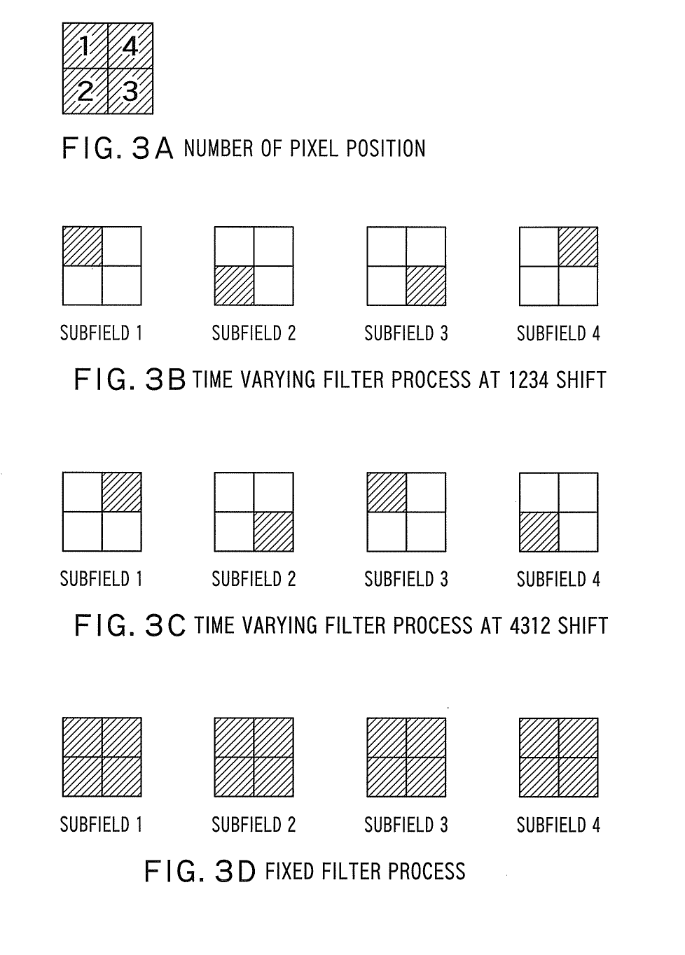

A plurality of shift schemes of the filter may be conceived. If each pixel position of 2×2 pixels in the input image is numbered as shown in FIG. 3A, the pixels are selected in the order of 1, 2, 3 and 4 with a “1234” shift scheme, as shown in FIG. 3B. Specifically, in the display element of the display panel corresponding to the position of 1, the color component of this display element among color components at the positions of 1, 2, 3 and 4 for 2×2 pixels are displayed (light-emitted) in this order at four times the frame frequency.

Similarly, the pixels are selected in the order of 4, 3, 1 and 2 with a “4312” shift scheme, as shown in FIG. 3C. Specifically, in the display element of the display panel corresponding to the position of 1, the color component of this display element among color components at the positions of 1, 2, 3 and 4 for 2×2 pixels are displayed in the order of 4, 3, 1 and 2 at four times the frame frequency.

In FIG. 3D, the filter process with a 2×2 fixed filter (hereinafter referred to as a 2×2 fixed type) is explained. In the 2×2 fixed filter process, the average of four pixels at the positions of 1, 2, 3 and 4 is taken over all the subfields. For example, in the display element of the display panel corresponding to the position of 1, the light of the average of color component of this display element among color components at the positions of 1, 2, 3 and 4 for 2×2 pixels is emitted at four times the frame frequency.

The visual effects in making the time varying filter process will be described below based on the verification results by the present inventors.

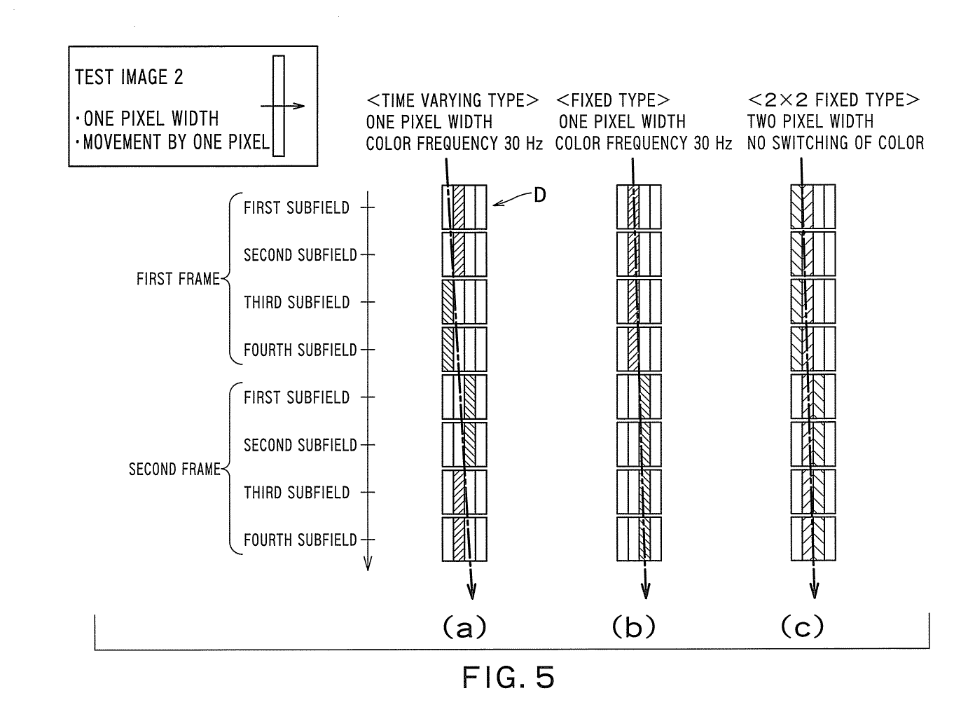

FIG. 4 shows an image displayed on the display panel for two frames on a subfield basis in a case where a still image (test image 1) having a line width of one pixel is inputted. Herein, it is supposed that each pixel (linear image having a width of one pixel) of the line indicated by L1 in FIG. 2A is inputted, and each pixel is white (e.g., all RGB having the same luminance). It is assumed that the frame frequency is 60 Hz. Reference numeral D typically designates the display panel of 4×4 display elements. The display panel D is partitioned into four sections, one section corresponding to one longitudinal line on the display panel of FIG. 2B. A hatching part represents a lighted part (four light emitting elements on one longitudinal line are lighted) on the display panel. In FIG. 4, a down direction in the figure is the elapsed time direction, and a broken line vector in the figure indicates the line of sight position in each subfield. Since the line of sight does not move in the still image, the line of sight points to a fixed position over time, and the transverse component of the broken line vector is not changed.

The <fixed type> of FIG. 4(b) involves an instance where a fixed filter process of 1×1 is performed. In this process, each display element on the display panel emits the light in each subfield, based on the pixel of the input image at the same position as itself. That is, since a sampling point corresponding to each display element is one point, the lights of R and G or G and B on one line are only emitted. In this example as described above, since each pixel of the line as indicated by L1 in FIG. 2A is inputted, the display elements (display elements of G and B) on the line of L2 are lighted in each subfield. That is, the longitudinal line of cyan (G and B are apparently mixed) is displayed at the position of L2 (a right rising hatching with fine pitch indicates cyan in the following), as shown in FIG. 4(b). The input image is white, but the output image is cyan. Such a color deviation is represented as coloration in the following.

The <2×2 fixed type> of FIG. 4(c) involves an instance where a fixed filter process of 2×2 is performed. In the fixed filter process of 2×2, the average of four pixels at the positions of 1, 2, 3 and 4 is taken in each subfield (the pixel on the input image at the same position as the display element on the display panel is made the position 1). The lines as indicated by L2 and L3 in FIG. 2B are displayed over each subfield, as shown in FIG. 4(c). Since the longitudinal lines displayed by the lines L2 and L3 appear mixed, the longitudinal line of white color with a line width of two lines is visually identified. In FIG. 4(c), a right falling hatching (left side) with rough pitch is cyan, its luminance being half the luminance of cyan as indicated in the <fixed type>. A right rising hatching (right side) with rough pitch is yellow, its luminance being half the luminance of yellow as indicated in the <time varying type> as described below (ditto).

The <time varying type> of FIG. 4(a) involves an instance where a time varying filter process using the 1234 shift scheme is performed. The time varying filter process of the 1234 shift scheme is sometimes called a U-character type filter process. The pixel of position 1 is selected in the first subfield, the pixel of position 2 is selected in the second subfield, the pixel of position 3 is selected in the third subfield, and the pixel of position 4 is selected in the fourth subfield. The position of the pixel on the input image at the same position as the display element on the display panel is made position 1. Accordingly, the line of G and B as indicated by L2 in FIG. 2B is lighted in the first subfield and the second subfield to display cyan, but is not lighted in the third subfield and the fourth subfield (see FIG. 4(a)). On the other hand, the line of R and G as indicated by L3 left adjacent to L2 is not lighted in the first subfield and the second subfield, but lighted in the third subfield and the fourth subfield to display yellow (a right falling hatching with fine pitch indicates yellow in the following). Hence, the longitudinal line of yellow is displayed off the longitudinal line of cyan. In the still image, since the longitudinal line of cyan and the longitudinal line of yellow are switched at high rate (60 Hz flicker)), the longitudinal lines of these two lines are mixed, so that the white longitudinal line with a line width of two lines is visually identified. This means that the almost same image as the <2×2 fixed type> as shown in FIG. 4(c) is visually identified.

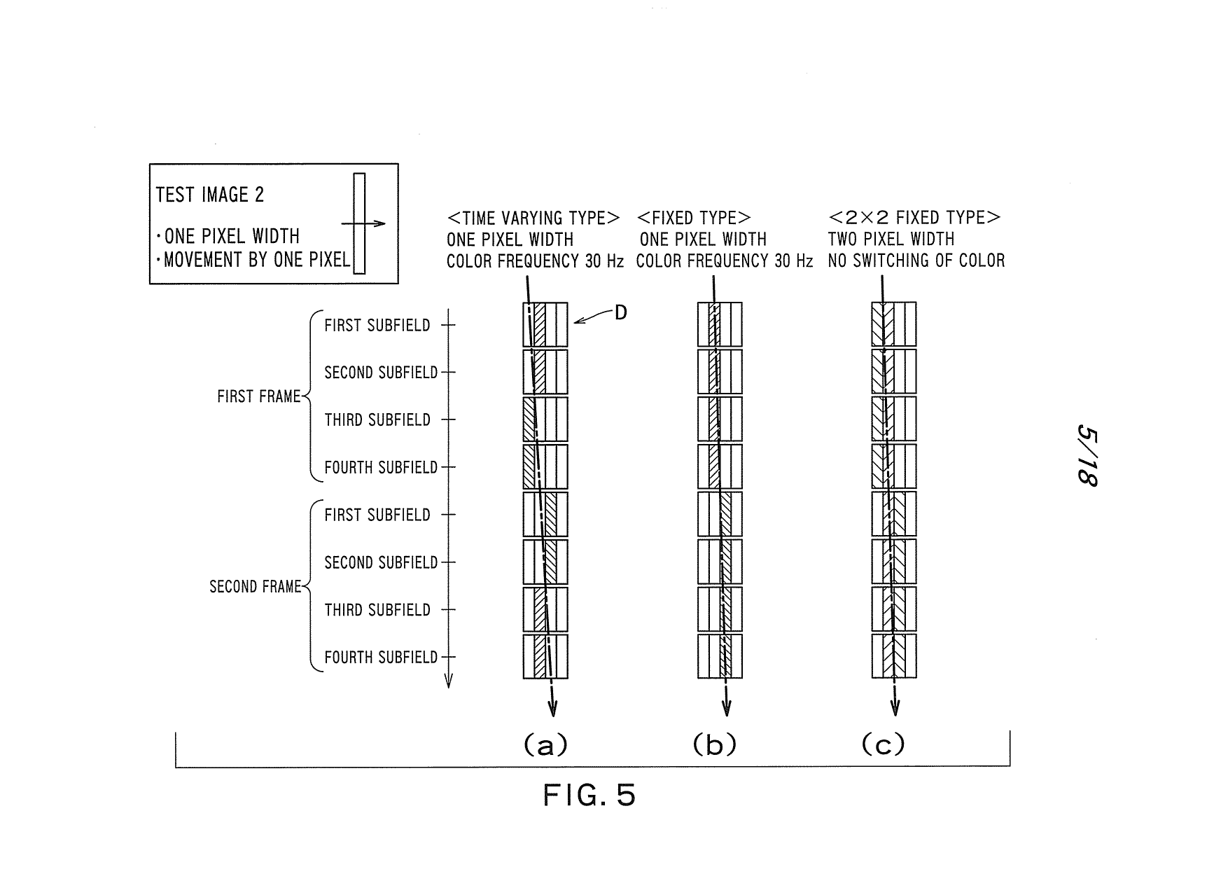

The similar consideration is made for the moving image moving by one pixel from left to right with a line width of 1. FIG. 5 shows an image displayed on the display panel for two frames on a subfield basis in a case where the moving image (test image 2) in which the longitudinal line with a line width of one pixel moves to the right by one pixel is inputted. Herein, it is assumed that the images of the lines as indicated by L1 and L4 in FIG. 2A are inputted in the order of L1 and L4.

In FIG. 5(a) to (c), the transition of the lighting position on the display panel over time is the same as in FIG. 4, except that the lighting line moves by one line to the right in the second frame. It is the movement of the line of sight that is greatly different from FIG. 4. The watcher feels that the longitudinal line is moved from left to right, and so the watcher moves the line of sight from left to right. That is, the watcher moves the line of sight along the transverse component of the broken line vector, so that the line of cyan and the line of yellow appear to overlap one another in the <fixed type> of FIG. 5(b). Hence, the white longitudinal line with a line width of one pixel is visually identified. This has a narrower line width than in the <2×2 fixed type> of FIG. 5(c) (visually identified as the white line with a thicker line width than the line width of one pixel), and corresponds to the line width of the actual input image. That is, it is meant that the resolution near double the resolution of the display panel can be obtained. However, since the switching frequency of the line of cyan and the line of yellow is 30 Hz, the flicker occurs. On the other hand, in the <time varying type> of FIG. 5(a), the longitudinal lines of cyan and yellow overlap without coloration (apparently white), but the line width visually identified is almost equivalent to that of the <2×2 fixed type>.

Further, the same consideration as above will be made for the moving image moving by two pixels from left to right with a line width of 1 as follows.

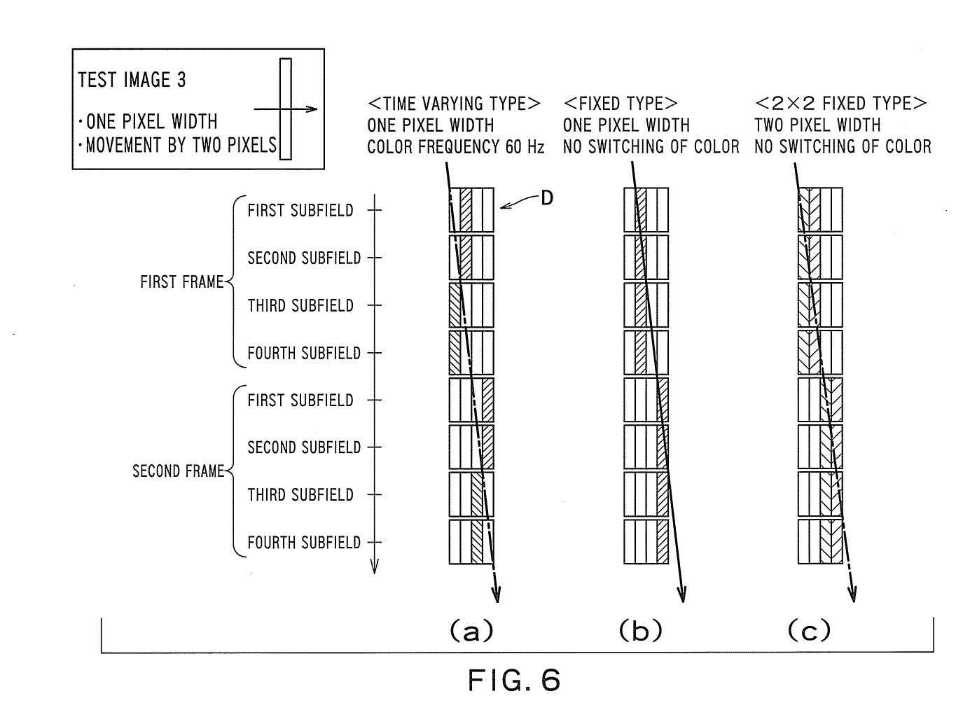

FIG. 6 shows an image displayed on the display panel for two frames on a subfield basis in a case where the moving image (test image 3) in which the longitudinal line with a line width of one pixel moves by two pixels (one line in the middle is skipped) is inputted. Herein, it is assumed that the images of the lines as indicated by L1 and L5 in FIG. 2A are inputted in the order of L1 and L5.

In the <2×2 fixed type> of FIG. 6(c), the white line with a line width of more than one pixel is visually identified. In the <fixed type> of FIG. 6(b), the longitudinal line of cyan is only obtained, and the longitudinal line of cyan with a line width of 1 is visually identified. That is, the coloration occurs. On the other hand, in the <time varying type> of FIG. 6(a), cyan and yellow are displayed, but the longitudinal lines with a line width of 2 in which the longitudinal line of cyan to the right and the longitudinal line of yellow to the left exist in parallel were visually identified. Though the coloration is not visually identified, like the <fixed type>, it does not appear that the colors are mixed when observed from nearby. With an impression from the observation, two lines having clear coloration were visually identified, rather than the blur. In this way, when the longitudinal line is moved, in the <fixed type>, the high resolution image with a line width of 1 can be obtained in both the test image 2 (see FIG. 5(b)) and the test image 3 (see FIG. 6(b)), but any coloration occurs in the test image 3. Herein, though the cases where the movement amount of the longitudinal line is 1 and 2 have been described above, the same consideration can be taken for the coloration of the <fixed type> in the case of the other movement amounts of the longitudinal line. In essence, whether or not the coloration occurs in the <fixed type> depends on whether the movement amount is the odd number of pixels or the even number of pixels.

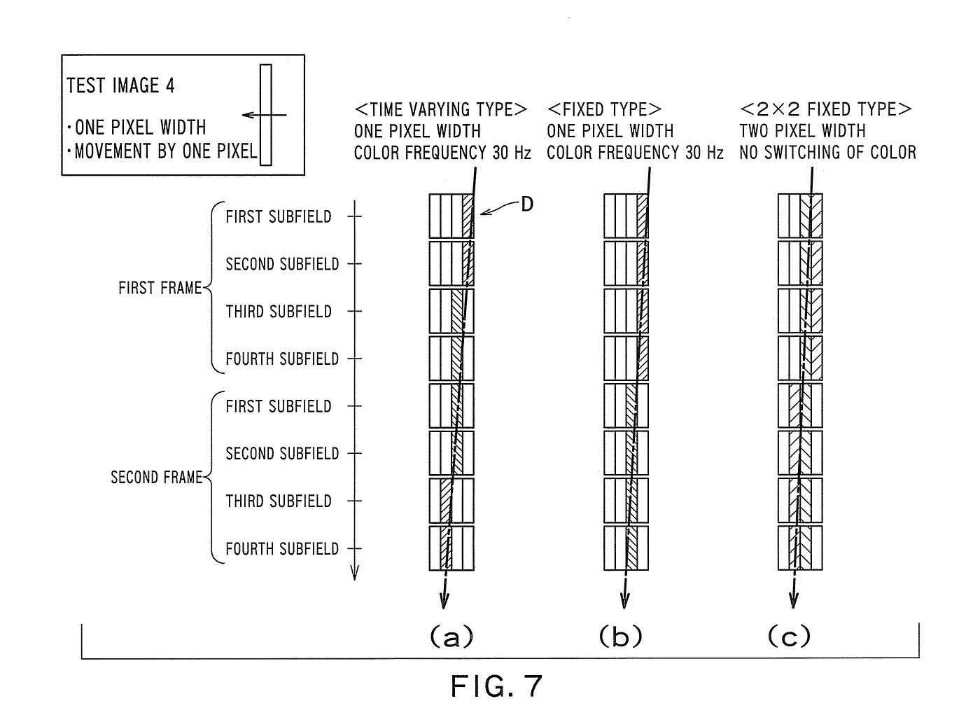

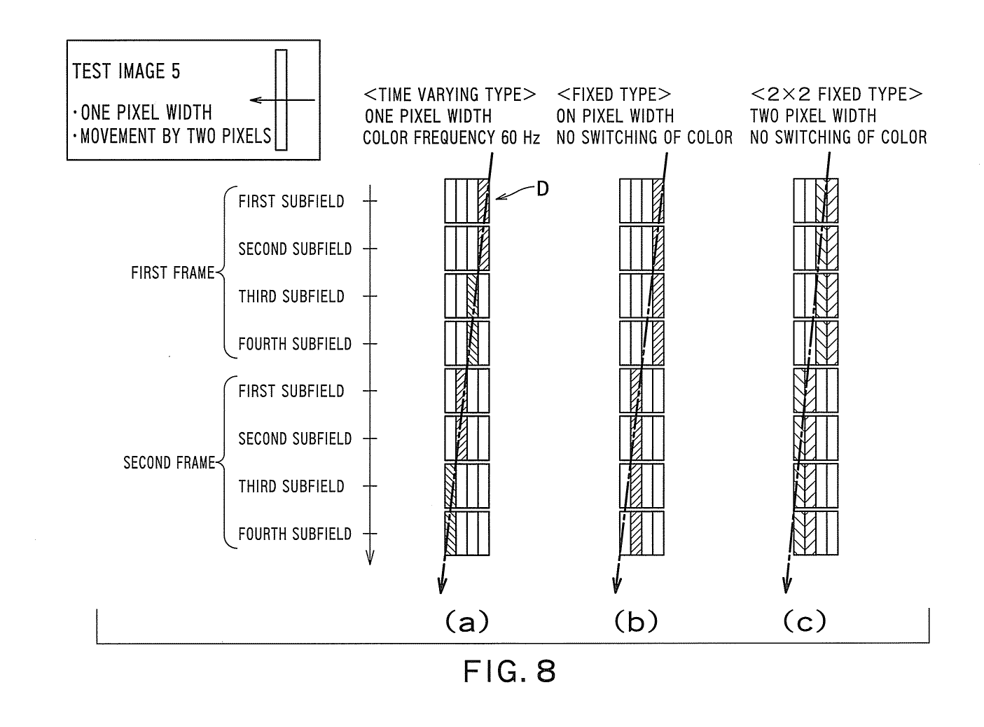

FIGS. 7 and 8 show the cases where the longitudinal line in the input image moves in the reverse direction (to the left) for the transverse shift (right shift from position 2 to position 3) in the time varying filter process. That is, though the transverse shift in the time varying filter process occurs in the same direction as the moving direction of the longitudinal line in the input image in FIGS. 5 and 6, they are in the mutually opposite directions in these cases of FIGS. 7 and 8.

In the case where the longitudinal line in the input image moves by the odd number of pixels (one pixel here) from right to left, like the test image 4 as shown in FIG. 7, the high resolution image with a line width of 1 is visually identified in the <fixed type> of FIG. 7(b), like the test image 2 of FIG. 5(b), and the high resolution image with a line width of 1 is also visually identified in the <time varying type> of FIG. 7(a). On the other hand, if the longitudinal line in the input image moves by the even number of pixels (two pixels here) from right to left, like the test image 5 as shown in FIG. 8, the coloration occurs in the <fixed type> of FIG. 8(b), and the high resolution image with a line width of 1 is visually identified in the <time varying type> of FIG. 8(a). In the <2×2 fixed type> of FIG. 7(c) and FIG. 8(c), the blurred white image with a line width of 2 appears in any case.

As will be clear from the above explanation using the test images 1 to 5, the <2×2 fixed type> is easy to use in the cases where various time space frequency components are required such as the natural image not dependent on the contents. However, since an image blur occurs, it is difficult to read the character. Also, it has been found that the movement direction and movement amount of an object (e.g., longitudinal line) have great influence on the image obtained through the time varying filter process. That is, it has been found that there is a strong correlation between the movement direction and movement amount of the object and the shift scheme. Specifically, it has been found that in the above example, when the movement direction of the object in the input image is from right to left, the “1234” shift scheme is suitable.

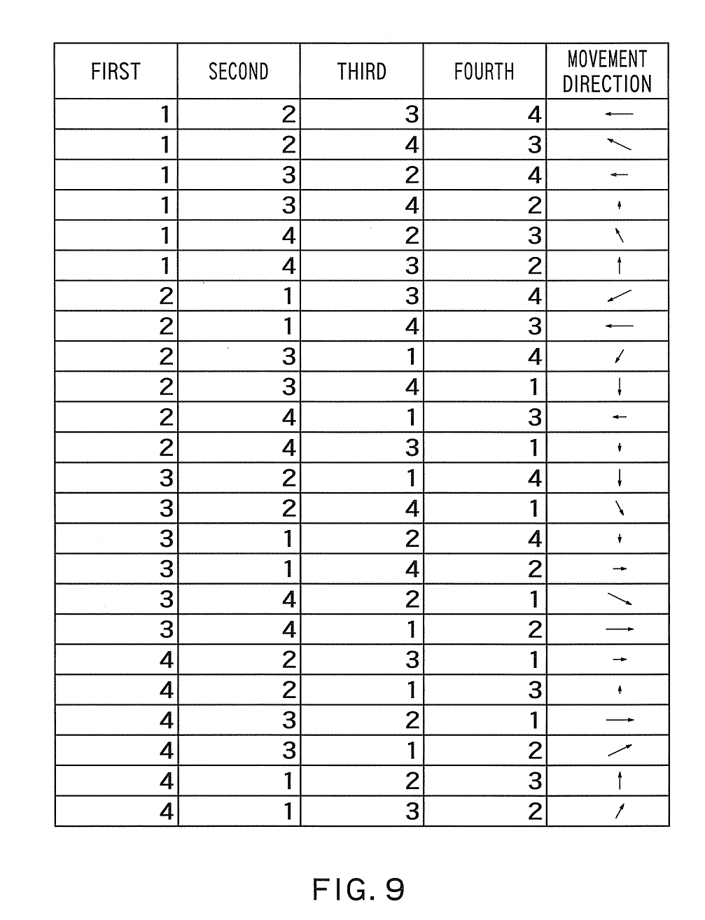

Thus, as a result of the examination about the shift schemes suitable for various movement directions, the present inventors obtained the relationship of a table as shown in FIG. 9.

In the table of FIG. 9, the values of the “first” to “fourth” items indicate the pixel positions of reference to be filtered in generating the first to fourth subfield images, in which the pixel positions are defined in accordance with FIG. 3A. That is, a set of the “first” to “fourth” values in one row represents one shift scheme. For example, the first row is the “1234” shift scheme, and the second row is the “1243” shift scheme. The “movement direction” represents the direction suitable as the movement direction of the object (body) for the shift scheme represented by the set of the “first” to “fourth” values. For example, the first row corresponds to the “1234” shift scheme as used in FIGS. 4 to 8, indicating that the shift scheme optimal for the object moving from right to left. Also, as another example, the “1432” shift scheme is the shift scheme optimal for the object moving from down to up. Also, plural examples of the same movement direction are shown in the table. For example, with the “1234” shift scheme and the “2143” shift scheme, the same effect appears for the object moving from right to left. Also, the short and long line segments with the same movement direction are shown in the table. For example, the “1324” shift scheme has the same arrow direction but the shorter length as compared with the “1234” shift scheme, which indicates that the “1324” shift scheme produces the smaller effect for the object moving from right to left than the “1234” shift scheme.

As can be understood from the above, the direction of motion (movement direction) of the object within the input image is extracted as the image feature by the image feature extraction unit 101, and the filter applied to each subfield in the time varying filter process can be decided (i.e., the display order of images generated by the four filters can be set) using the movement direction (e.g., component ratio in the X and Y axis directions orthogonal to each other) of the extracted object. In the following, this detailed example will be described.

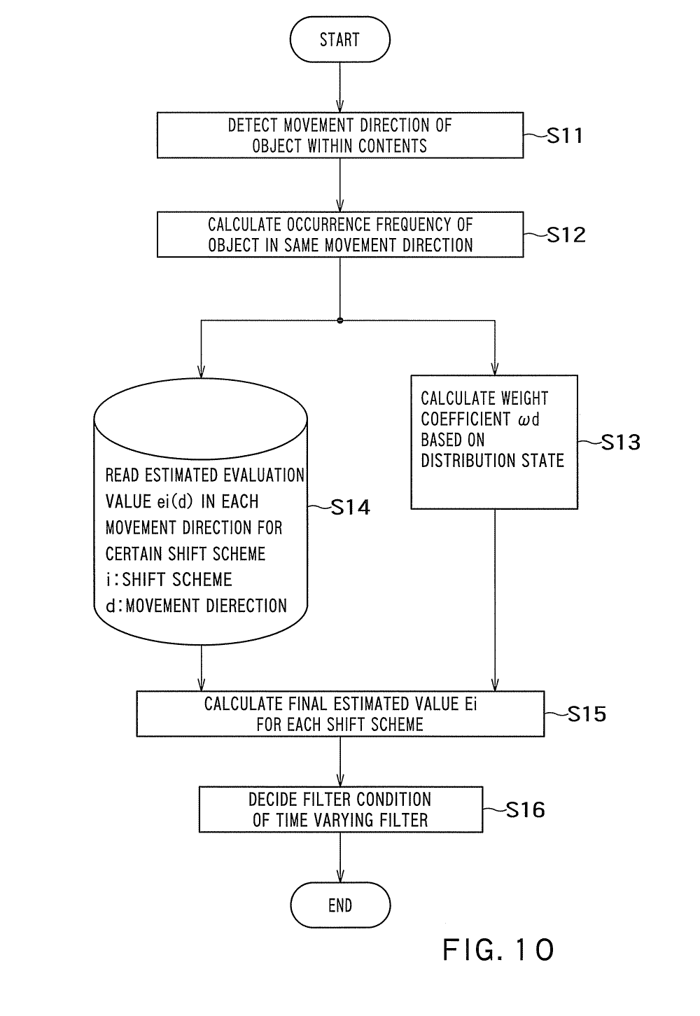

FIG. 10 is a flowchart showing one example of the processing flow performed by the image feature extraction unit 101 and the filter condition setting unit 102.

The image feature extraction unit 101 detects the movement directions of each object within the screen from the input image (S11), and obtains the occurrence frequency (distribution state), for example, the number of pixels, of the object in the same movement direction (S12). And the weight coefficient according to the occurrence frequency is calculated (S13). For example, the number of pixels of the object in the same direction divided by the total number of pixels of the input image is the weight coefficient.

Next, the filter condition setting unit 102 reads the estimated evaluation value decided by the shift scheme and the movement direction from the prepared table data for each object (S14), and obtains the final estimated value by weighting the read estimated evaluation values with the weight coefficients calculated at S13 and adding the weighted estimated evaluation values over all the movement directions (S15). This is performed for the candidates of all the shift schemes described in the table of FIG. 9, for example. And the shift scheme for use in the time varying filter process is decided based on the final estimated value obtained for the candidates of each shift scheme (S16). In the following, the steps S13 to S16 will be described in more detail.

First of all, a method for deriving an estimation evaluation expression of calculating the estimated evaluation value will be described below. The present inventors observed a variation of the evaluation values with each shift scheme for the 2×2 fixed type, using the subjective evaluation experiment. In the subjective evaluation experiment, the image of the 2×2 fixed type is disposed on the left side, and the image with each shift scheme is displayed on the right side, whereby the image quality of the image with each shift scheme for the image of the 2×2 fixed type was assessed at five stages of (5) excellent, (4) good, (3) equivalent, (2) bad, and (1) very bad. Hence, it follows that the image quality of the image of the 2×2 fixed type is the value of 3. As a result, it was confirmed that there are the shift schemes for producing the opposite effects for the objects in the same movement direction. Thus, the estimation evaluation expression Y=ei(d) for the shift scheme i was obtained by changing the movement direction. Herein, d designates a discrepancy (difference of angle) between the movement direction based on the table of FIG. 9 and the movement direction of the object within the contents, in which d is set to 0° for no discrepancy and to 180° for the opposite directions. Also, if the weight coefficient based on the occurrence frequency is wd, the final estimated value is obtained from the following formula (1).

$$Ei = {\sum }_{d = 0}^{180} ϖ d \times ei ( d ) \qquad [ Formula 1 ]$$

Thereby, it is expected that when Ei is equal to 3, the same image quality as the 2×2 fixed type is obtained by the shift scheme i, when Ei is greater than 3, the better image quality than the 2×2 fixed type is obtained by the shift scheme i, and when Ei is less than 3, the worse image quality than the 2×2 fixed type is obtained by the shift scheme i. Hence, a method for deciding the shift scheme at S16 may involve deciding the shift scheme in which the final estimated value is the largest, and adopting the shift scheme, if the final estimated value of the shift scheme is greater than 3, or adopting the 2×2 fixed filter, if the final estimated value is smaller than or equal to 3.

Moreover, as a result of examination for the possible factor becoming the feature of the input image other than the movement direction, the present inventors found that the following features have the influence on the image quality of the output image. The moving speed of the object in (1) corresponds to the movement amount described above.

(1) Moving speed of the object: ei, d (speed)

(2) Contrast of the object: ei, d (contrast)

(3) Space frequency of the object: ei, d (frequency)

(4) Edge inclination of the object: ei, d (edge intensity)

(5) Color component ratio of the object: ei, d (color)

Herein, ei, d (x) indicates the estimated evaluation value of the object having a feature amount x in a difference d in the movement direction with the shift scheme i. For example, when the difference between the movement direction of the object and the optimal movement direction for the “1234” shift scheme is 30°, and the speed of the object is “speed”, the estimated evaluation value is e_{1234 shift scheme, 30°} (speed). The estimated evaluation values for the above features (1) to (5) can be derived from the same subjective evaluation experiments as above. The methods for extracting the feature amounts of the features will be described below in the fourth to seventh embodiments.

Two examples of acquiring the final estimated value using the estimated evaluation values ei, d(x) based on the feature amounts of (1) to (5) are presented below. Herein, the moving speed of the object is adopted as the feature amount.

In a first example, first of all, ei, d (speed) is obtained for each object within the input image. Next, each estimated evaluation value is multiplied by the occurrence frequency of each object, and the multiplication results are added. Thereby, the final estimated value is obtained. And the shift scheme in which the final estimated value is the largest is selected.

A second example is suitably employed in the case where it is troublesome to prepare the table data storing the estimated evaluation values for the differences in all the movement directions. In this second example, the estimated evaluation value for only the movement direction suitable for each shift scheme is prepared for each shift scheme. For example, in a case of the “1234” shift scheme, e_{1234 shift scheme, 0°} (speed) only is prepared. And the shift scheme (here the “1234” shift scheme) suitable for the movement direction of the certain object within the input image (contents) is selected, and the estimated evaluation value e_{1234 shift scheme} (speed) (0° is omitted) for the shift scheme is acquired. Similarly, the optimal shift scheme is selected for the object having another movement direction within the contents, and the estimated evaluation value of the shift scheme is acquired. And the estimated evaluation value is multiplied by the occurrence frequency of each object, and the multiplication results are added to obtain the final estimated value. In this case, since the influence in the movement direction unsuitable for the certain shift scheme is not considered, the precision of the final estimated value is lower.

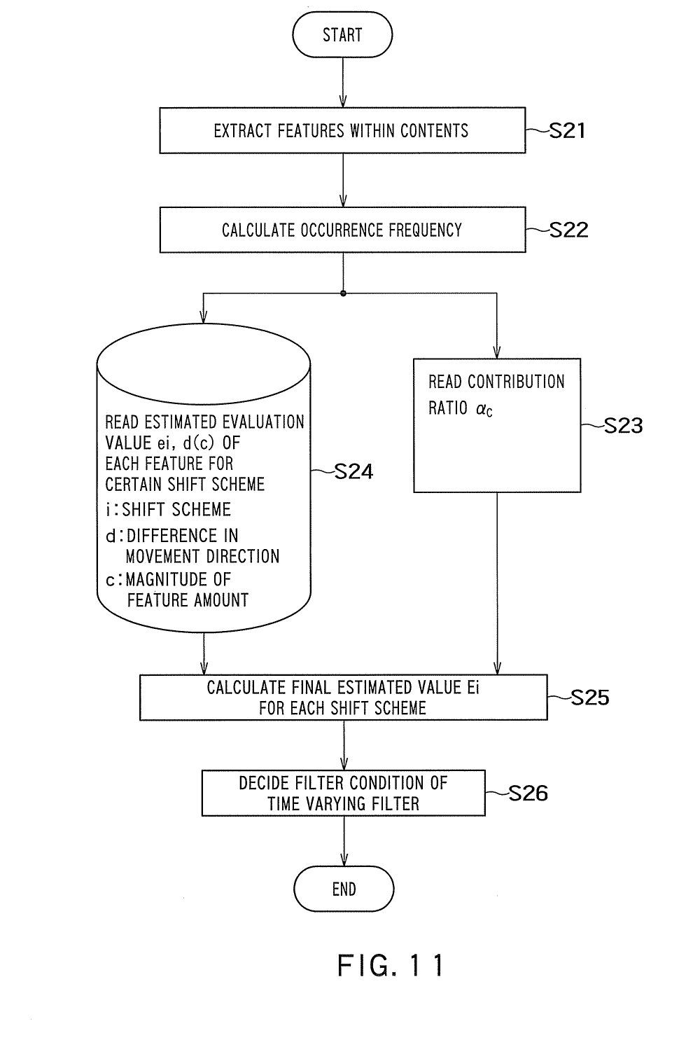

FIG. 11 is a flowchart showing another example of the processing flow performed by the image feature extraction unit 101 and the filter condition setting unit 102.

The image feature extraction unit 101 extracts features for each object within the contents from the input image (S21), and obtains the occurrence frequency of each object (S22). Next, a contribution ratio α_{c} in the following formula (2) for each feature is read with the shift scheme i and the difference d in the movement direction of the object, and the estimated evaluation value ei, d(c) in the formula (2) is read for each feature (523). The computation of the formula (2) is performed using the read α_{c} and ei, d(c) read for each feature, whereby the estimated value (intermediate estimated value) Ei′ is obtained per object (S24). The intermediate estimated value Ei′ obtained for each object is multiplied by the occurrence frequency, and the multiplication results are added to obtain the final estimated value Ei (S25). The shift scheme having the largest final estimated value (filter condition for the time varying filter) is adopted by comparing the final estimated values for the shift schemes (S26).

$${Ei}^{′} = {\sum }_{c} {α}_{c} \times ei , d ( c ) \qquad [ Formula 2 ]$$

In the formula (2), i is the shift scheme, d is the difference between the movement direction of the object and the movement direction suitable for the certain shift scheme, c is the magnitude of the certain feature amount, ei, d(c) is the estimated evaluation value for each feature in the certain shift scheme, Ei is the estimated value (intermediate estimated value) for the certain object, and α_{c} is the contribution ratio of the feature for the intermediate estimated value Ei′. The contribution ratio α_{c} can be obtained by the subjective evaluation experiment for each shift scheme.

More particularly explaining the above process, for the certain shift scheme, the estimated evaluation value ei, d(c) is obtained from the feature amount of the object within the input screen, for example, the speed of the object, and multiplied by the contribution ratio α_{c}. And this is performed for each feature amount c, and the multiplication results for the feature amounts c are all added to obtain the intermediate estimated value Ei′. The final estimated value is obtained by multiplying the intermediate estimated value Ei′ by the occurrence frequency of each object (e.g., the number of pixels of the object divided by the total number of pixels), and adding the multiplication results for all the objects. The same computation for other shift schemes is performed to obtain the final estimated values. And the shift scheme with the highest final estimated value is adopted. However, since it is troublesome to compute the difference between the movement direction of the object and the movement direction suitable for the shift scheme for all the objects within the input screen, the following method may be employed instead of the above method. First of all, the main motion within the input screen is obtained. For example, the main motion is limited to one or two movement directions with the large occurrence frequency. And the final estimated value for each shift scheme is obtained by considering the respective movement directions only, and the shift scheme with the highest final evaluated value is selected. The present inventors have confirmed that the proper shift scheme can be selected in most cases by this method.

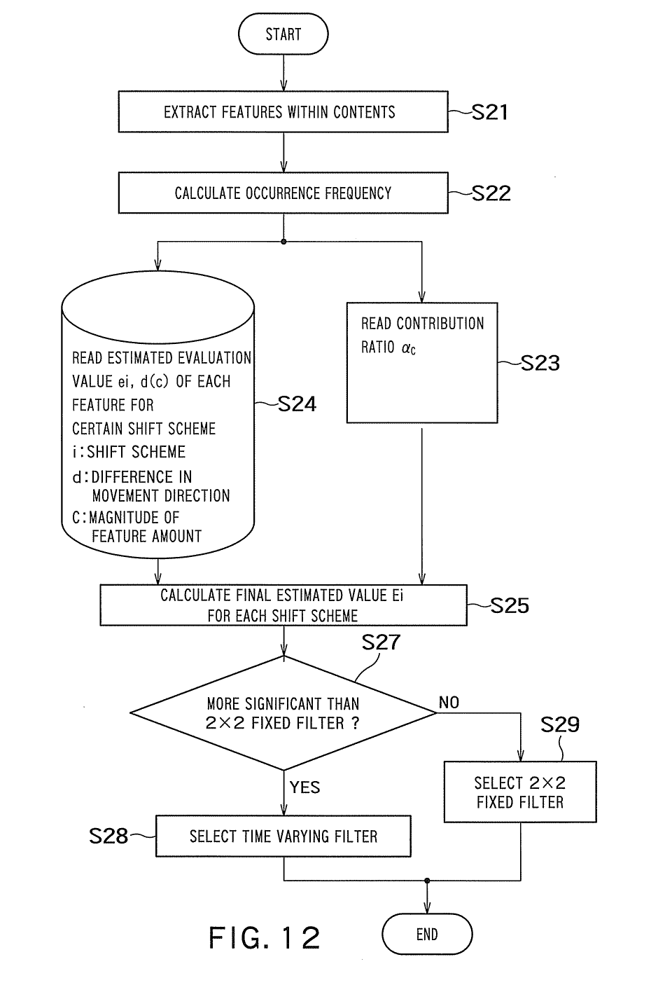

FIG. 12 shows a partially modified example of the method as shown in FIG. 11. The step S26 is deleted from FIG. 11, and instead, the steps S27 to S29 are added after the step S25. At S27, the final estimated value for the shift scheme having the highest final estimated value and the evaluation value of the 2×2 fixed filter are compared. If the final estimated value of the shift scheme is larger (YES at S28), the shift scheme is selected, namely, the time varying filter is selected (S28), or if the evaluation value of the 2×2 fixed filter is larger (NO at S27), the 2×2 fixed filter is selected (S29). This reason is that if the shift scheme not adaptable for the input image is adopted in the time varying filter process, the image quality is worse than the 2×2 fixed filter. In the subjective evaluation experiment made by the present inventors, when the image obtained by the 2×2 fixed type is a reference image, and a variation of the evaluation values depending on the shift schemes was observed, the opposite results for two shift schemes were obtained. That is, the results were that the one was better than the 2×2 fixed type, and the other was worse than the 2×2 fixed type.

With this embodiment as described above, the K filters (K=4 in FIG. 9) are ordered based on the features of the input image to set the display order of images generated by the K filters, and the filter process is performed for the input image, based on the K filers, to generate the K subfield images, each subfield image being displayed in the set display order in one frame period of the input image, whereby the user can visually identify the moving image having the higher space resolution than the space resolution of the dot matrix display device by effectively utilizing the visual characteristics of the person.

### Second Embodiment

In a second embodiment of the invention, another example of the time varying filter process in the subfield image generation unit 102 will be described below.

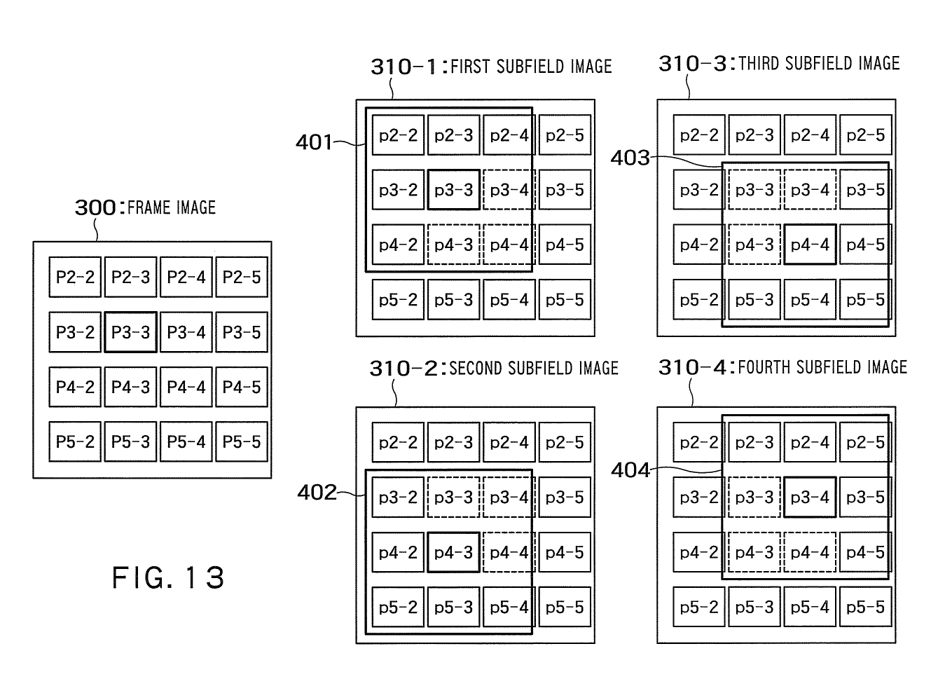

FIG. 13 shows the example for generating the first to fourth subfield images 310-1, 310-2, 310-3 and 310-4 from a frame image 300. The subfield images 310-1, 310-2, 310-3 and 310-4 are generated by changing the filter coefficients for each subfield.

The pixel value at the display element position of P3-3 on the display panel is obtained for the first subfield image 310-1 by convoluting a filter with 3×3 taps into the 3×3 image data at the display element positions (P2-2, P2-3, P2-4, P3-2, P3-3, P3-4, P4-2, P4-3, P4-4) within a frame 401. The pixel value of the display element position of P3-3 is obtained for the second subfield image 310-2 by convoluting a filter with 3×3 taps into the 3×3 image data at the display element positions (P3-2, P3-3, P3-4, P4-2, P4-3, P4-4, P5-2, P5-3, P5-4) within a frame 402. The pixel value of the display element position of P3-3 is obtained for the third subfield image 310-3 by convoluting a filter with 3×3 taps into the 3×3 image data at the display element positions (P3-3, P3-4, P3-5, P4-3, P4-4, P4-5, P5-3, P5-4, P5-5) within a frame 403. The pixel value of the display element position of P3-3 is obtained for the fourth subfield image 310-4 by convoluting a filter with 3×3 taps into the 3×3 image data at the display element positions (P2-3, P2-4, P2-5, P3-3, P3-4, P3-5, P4-3, P4-4, P4-5) within a frame 404.

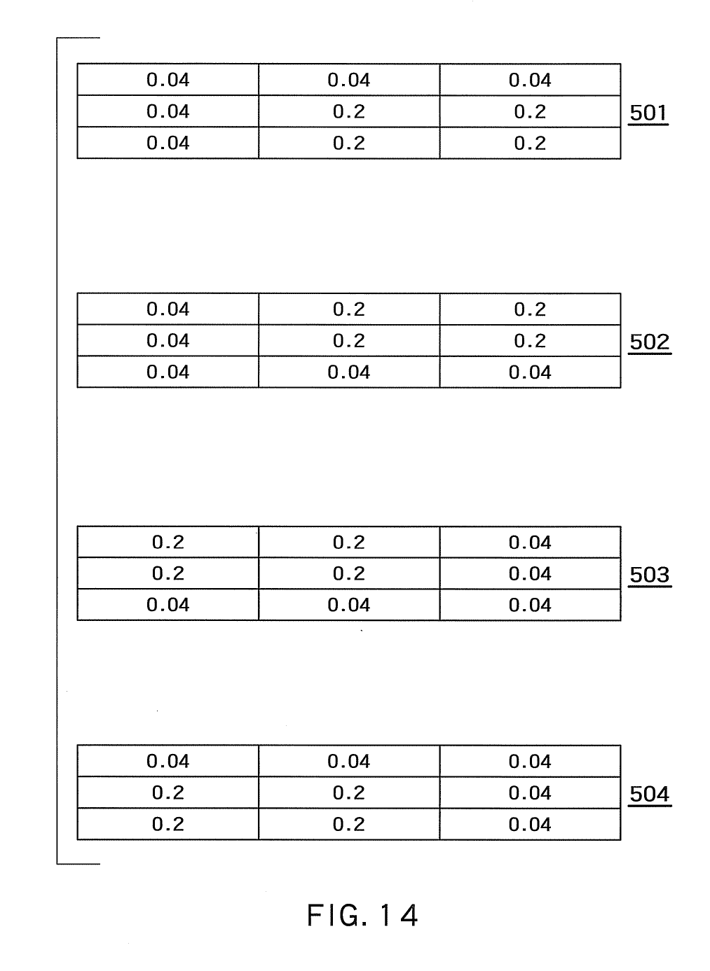

A specific way of performing the filter process involves preparing the filters 501 to 504 (time varying filters) with 3×3 taps, and convoluting a filter 501 into the 3×3 image data of the input image corresponding to the frame 401, as shown in FIG. 14. Similarly, the filters 502 to 504 are convoluted into the 3×3 image data of the input image corresponding to the frames 402 to 403. Thereby, the pixel values at the display element position P3-3 in the first to fourth subfields are obtained.

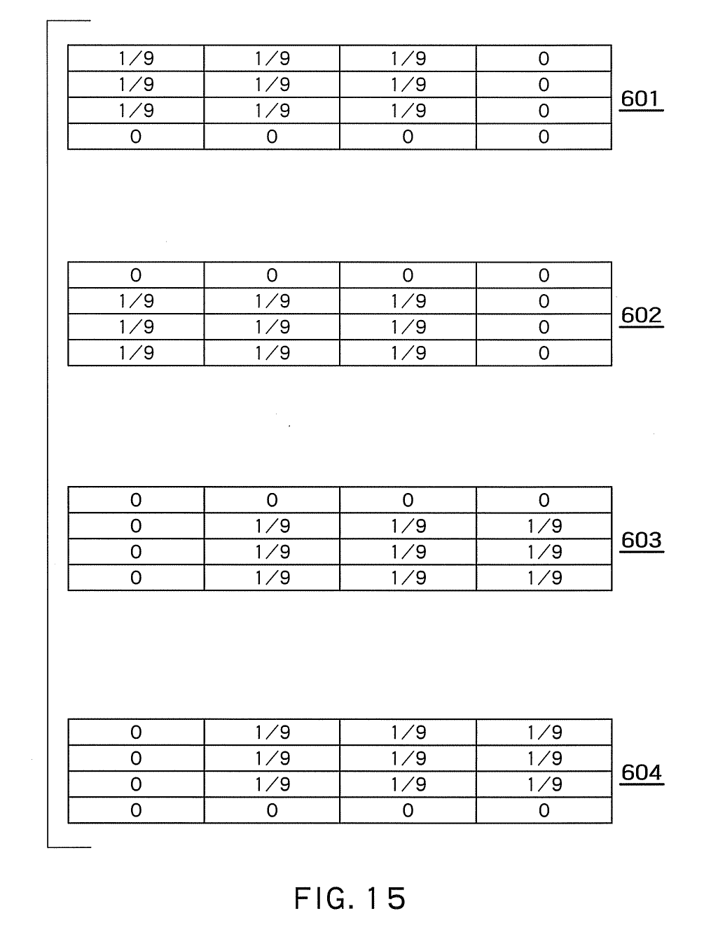

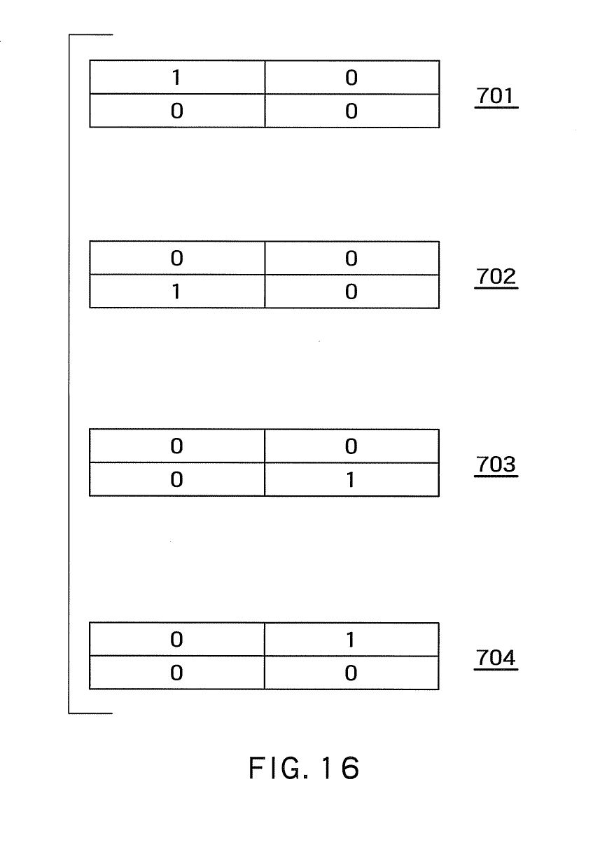

Or it involves preparing the filters 601 to 604 (time varying filters) with 4×4 taps that are substantially the filters with 3×3 taps, and sequentially convoluting these filters 601 to 604 into the 4×4 image data, as shown in FIG. 15. Thereby, the image values at the display element position P3-3 in the first to fourth subfields may be obtained. That is, the filter process is performed while the effective positions (not zero) of filter coefficients within the filter are shifted along the shift direction. FIG. 16 shows four filter examples (K=4) (in the case of the 1234 shift scheme) for use in performing the filter process in the first embodiment. The time varying filter process using the 1234 shift scheme in the first embodiment corresponds to the filter process for sequentially convoluting the filters 701 to 704 with 2×2 taps as shown in FIG. 16 into the 2×2 image data.

### Third Embodiment

In a third embodiment of the invention, a non-linear filter is used for the time varying filter process in the subfield image generation unit 102.

The non-linear filter is typically a median filter or ε filter. The median filter is employed to remove an impulse noise and the ε filter is employed to remove a small signal noise. The same effects can be obtained by employing these filters in this embodiment. In the following, an example of generating the subfield images by performing the filter process using the non-linear filter will be described below.

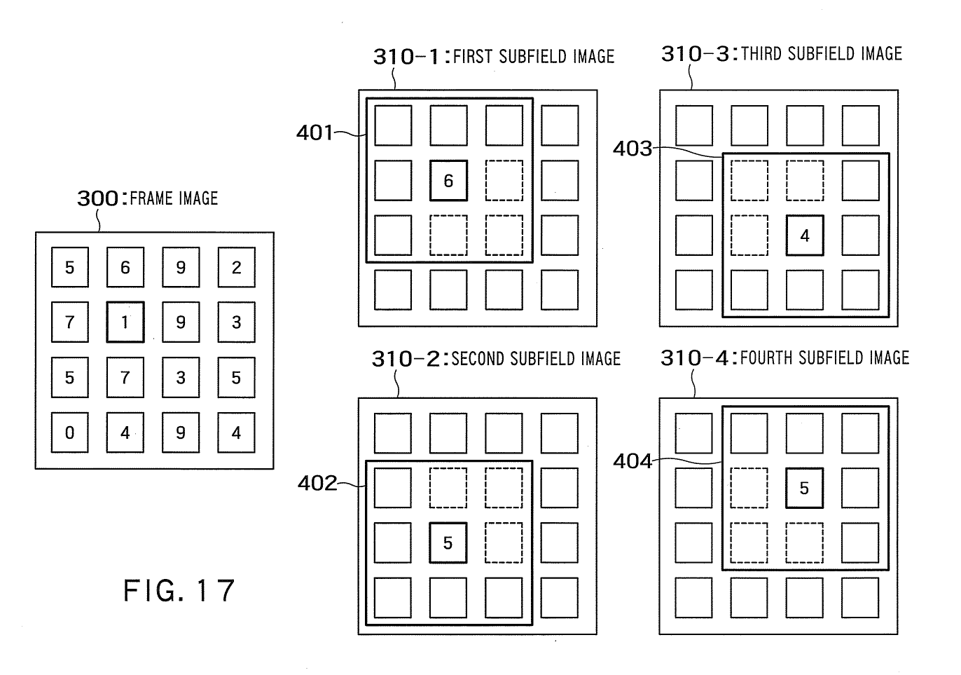

For example, when the median filter is employed, the pixel values of a frame image (input image) corresponding to the display areas are arranged in the descending order in the 3×3 display areas, and the medial pixel value among the arranged pixel values is selected as the pixel value of the noticed display element (medial display element in the display areas), as shown in FIG. 17. For example, in a case of the first subfield image 310-1, the pixel values of the frame image 300 corresponding to the display elements within the frame 401 are arranged in the descending order, such as “9, 9, 7, 7, 6, 5, 5, 3, 1”, and the medial pixel value is “6”. Hence, the pixel value of the medial display element within the frame 401 is “6”.

On the other hand, when the ε filter is employed, the absolute values of differences (hereinafter a differential value) between the noticed pixel value (e.g., pixel value of the medial pixel in the 3×3 areas of the frame image) and the peripheral pixel values (e.g., pixel value of the pixel other than the medial pixel in the 3×3 areas) are obtained, as shown in the formula (3) as below. And if the differential value is equal to or smaller than a certain threshold ε, the pixel value of the peripheral pixel is directly left without being replaced with the noticed pixel value, and if the differential value is greater than the certain threshold ε, the peripheral pixel value is replaced with the noticed pixel value. And the pixel value of the noticed display element in the subfield image is obtained by making a convolution operation on the image data after replacement in the 3×3 areas through the filter with 3×3 taps.

$$W ( x , y ) = {\sum }_{i = - k}^{k} {\sum }_{j = - l}^{l} T ( i , j ) \cdot Y ( x - i , y - j ) \\ \begin{matrix}if & \vert X ( x - i , y - j ) - X ( x , y ) \vert \leq ɛ & Y ( x - i , y - j ) = X ( x - i , y - j ) \\ if & \vert X ( x - i , y - j ) - X ( x , y ) \vert > ɛ & Y ( x - i , y - j ) = X ( x , y )\end{matrix} \qquad [ Formula 3 ]$$

Where W(x,y) is the output value, T(i,j) is the filter coefficient, and X(x,y) is the pixel value.

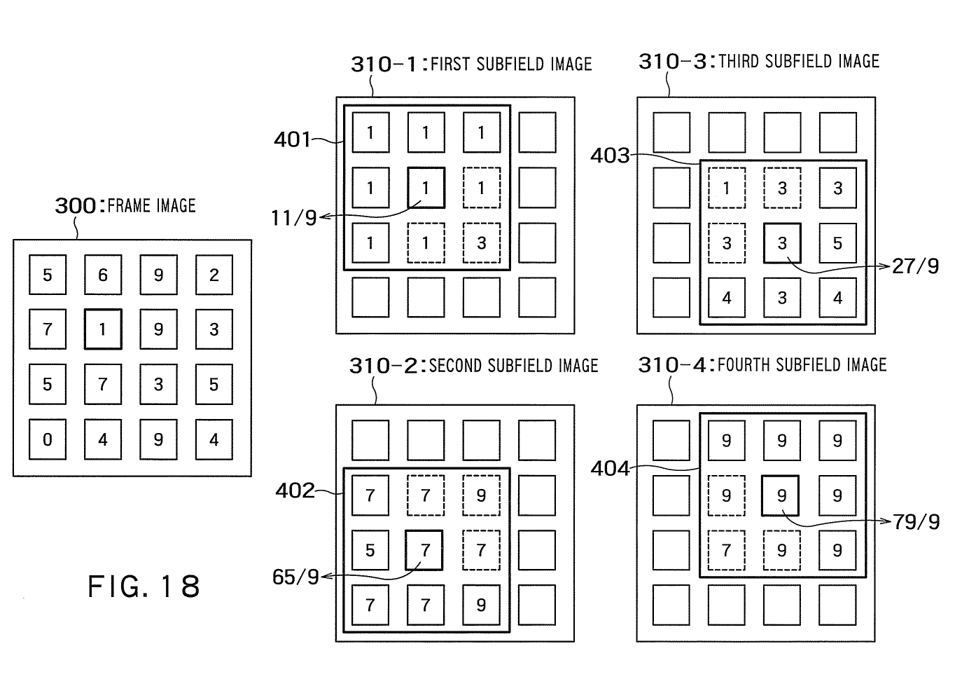

FIG. 18 shows an example of the filter process in the case where the ε filter is employed. The threshold ε is 2, and the substance within each square indicates the pixel value computed by the formula (3). Also, the value indicated by the leader line is the value after the filter process. The filter coefficients of the filter with 3×3 taps are all 1/9.

For example, when the first subfield image 310-1 is generated, the noticed pixel value in the frame image 300 is “1”, taking note of the medial display element within the frame 401. The differences between the noticed pixel value and the peripheral pixel values are obtained as “4(=5−1), 5(=6−1), 8(=9−1), 8(=9−1), 2(=3−1), 6(=7−1), 4(=5−1), 6(=7−1)”, clockwise from top left of the noticed pixel. Hence, the pixel value “3” at the pixel position where the difference is greater than ε=2 is directly used, and the pixel values at other pixel positions are replaced with the noticed pixel value “1” (see each value within the frame 401). By convoluting the filter with 3×3 taps where all the filter coefficients are 1/9 into the values after replacement, the pixel value “ 11/9” of the noticed display element within the frame 401 in the first subfield image 310-1 is obtained.

As described above, when the median filter is employed, the luminance is changed from 6 to 5 to 4 to 5 between the subfields, whereby the average luminance for one frame is 5, as shown in FIG. 17. On the other hand, when the ε filter is employed, the luminance is changed from 11/9 to 65/9 to 27/9 to 79/9 between the subfields, whereby the average luminance for one frame is 5.06, as shown in FIG. 18. In this case, the average luminance is substantially not different, but is different in a variation in the luminance between the subfields, whereby the use method can be selected in accordance with the purposes.

### Fourth Embodiment

In a fourth embodiment of the invention, an example of extracting the moving speed of the object within the input image as the image feature extracted by the image feature extraction unit 101 will be described below.

A method for acquiring the moving speed involves detecting the motion using a plurality of frame images of input image signals, and outputting it as the motion information. For example, in the block matching for use in encoding the moving image such as Moving Picture Experts Group (MPEG), input image signals for one frame is held in a frame memory, and the motion is detected using the image signals delayed by one frame and the input image signals, namely, two frame images adjacent over time. More particularly, n-th frame (reference frame) of the input image signals is divided into square areas (blocks), and an analogous area to the (n+1)-th frame (searched frame) is searched for every block. A method for finding the analogous area typically employs an absolute value difference sum (SAD) or a square sum of differences (SSD). When the SAD is employed, the following expression holds.

$$SAD ( \vec{d} ) = {\sum }_{x ∈ B} \vert f ( \vec{x} , m ) - f ( \vec{x} + \vec{d} , m + 1 ) \vert \qquad [ Formula 4 ]$$

Where m and m+1 indicate the frame number, \vec{X} indicates the certain pixel position within the block B, and \vec{d} indicates the moving vector. And f(\vec{X},m) indicates the luminance of pixel. Hence, the formula (4) calculates the sum of luminance differences between each pixels within the block. The minimum sum is searched for the block, and the movement amount \vec{d} at that time is the moving vector to be obtained for the block. The occurrence frequency of the moving speed can be obtained by grouping the obtained moving vectors within the input screen according to the moving speed.

Herein, in the first embodiment, the moving speed to be referenced in deciding the shift scheme can be changed according to the occurrence frequency. For example, the moving speed beyond the certain occurrence frequency may be only employed. And, the value of the weight coefficient (that can be obtained by the subjective evaluation experiment) concerning the moving speed of the object within the screen multiplied by the occurrence frequency of the motion is the feature amount concerning the moving speed of the object.

As the moving speed is increased, there is a greater difference between the time varying filter process and the 2×2 fixed filter process. Specifically, if the shift scheme suitable for the movement direction is employed, the time varying filter process produces the better image quality. However, if the shift scheme unsuitable for the movement direction is employed, the time varying filter process is inferior in the image quality. However, the present inventors have confirmed from the experiments that the image quality of the time varying filter process converges into the image quality of the 2×2 fixed filter process when the moving speed exceeds the certain threshold.

### Fifth Embodiment

In a fifth embodiment of the invention, an example of extracting feature amounts concerning the contract and the space frequency of the object in the input image as the image features extracted by the image feature extraction unit 101 will be described below.

The contrast and the space frequency of the object are obtained by making the Fourier transform for the input image. The contrast is equivalent to the magnitude of spectral component at the certain space frequency. It was found from the experiments that when the contrast is great, a variation in the image quality is easily detected, and in an area (edge area) where the space frequency is high, a variation in the image quality is also easily detected. Thus, the screen is divided into plural blocks, the Fourier transform is performed for each block, the spectral components in each block are sorted in the descending order, and the largest magnitude of spectral component and the space frequency at that time are adopted as the contrast and the space frequency for each block. And, the number of same contrast and same space frequency is counted over all the blocks included in the object, the weight coefficients (that can be obtained by the subjective evaluation experiments) concerning the contrast and the space frequency of the object are multiplied by the occurrence frequency of each contrast and each space frequency, multiplied results are added, respectively, and thereby the feature amounts concerning the contrast and the space frequency of the object are obtained.

### Sixth Embodiment

In a sixth embodiment of the invention, an example of extracting the edge intensity of the object within the input image as the image feature extracted by the image feature extraction unit 101 will be described below.

The edge intensity of the object is obtained by extracting the edge direction and strength by a general edge detection method. It is known from the experiments that as the edge intensity is more perpendicular to the optimal movement direction of the object depending on the shift scheme, a variation in the image quality is detected more easily.

Hence, since the influence of the edge intensity is different depending on the shift scheme, this edge intensity is reflected to the weight coefficient (obtained by the subjective evaluation experiment, for example, the coefficient is greater as the edge intensity is more perpendicular to the movement direction) concerning the edge intensity of the object. The weight coefficient concerning the edge intensity of the object within the screen multiplied by the frequency of edge intensity is the feature amount concerning the edge intensity of the object.

### Seventh Embodiment

In a seventh embodiment of the invention, an example of extracting the color component ratio of the object within the input image as the image feature extracted by the image feature extraction unit 101 will be described below.

The reason for obtaining the color component ratio of the object is that since the number of green elements is greater than the number of blue or red elements due to a Bayer array on the ordinary LED display device, the influence on the image quality depends on the color component ratio. Simply, the average luminance is obtained for each color component in the object. This is reflected to the weight coefficient (obtained beforehand by the subjective evaluation experiment) concerning the color component ratio of the object. The weight coefficient of the object for each color within the screen multiplied by the color component ratio included in the object is the feature amount concerning the color of the object.

What is claimed is:

1. An apparatus for image processing for displaying an image on a dot matrix type display device having a plurality of display elements each emitting single light, comprising:
an image input unit configured to input an input image having pixels each including one or more color components;
an image feature extraction unit configured to extract a feature of the input image;
a filter processor configured to generate K subfield images by performing a filter process using K filters for the input image of one frame;
a display order setting unit configured to set a display order of the K subfield images based on the feature of the input image; and
an image display control unit configured to display the K subfield images in accordance with the display order on the display device in one frame period of the input image.

2. The apparatus according to claim 1, wherein the display order setting unit computes evaluation values of a plurality of candidates for the display order and selects a candidate from among the plurality of candidates based on the evaluation values.

3. The apparatus according to claim 2, wherein the display order setting unit selects a candidate having the highest evaluation value.

4. The apparatus according to claim 1, wherein the image feature extraction unit extracts a moving direction of an object included in the input image as the feature of the input image.

5. The apparatus according to claim 4, wherein the image feature extraction unit further extracts a moving speed of the object as the feature of the input image.

6. The apparatus according to claim 5, wherein the image feature extraction unit further extracts a contrast of the object as the feature of the input image.

7. The apparatus according to claim 5, wherein the image feature extraction unit further extracts frequencies of each space frequency included in the object as the feature of the input image.

8. The apparatus according to claim 5, wherein the image feature extraction unit further extracts an edge intensity of the object as the feature of the input image.

9. The apparatus according to claim 5, wherein the image feature extraction unit further extracts ratios of each color component in the object as the feature of the input image.

10. The apparatus according to claim 1, wherein each pixel of the input image has three color components of red, green and blue.

11. The apparatus according to claim 1, wherein
the display device includes
a plurality of first element arrays in each of which a first display element emitting the light of a first color and a second display element emitting the light of a second color are arranged alternately in a first direction, and
a plurality of second element arrays in each of which the first display element and a third display element emitting the light of a third color are arranged alternately in the first direction, and
the first element arrays and the second element arrays are arranged alternately in a second direction orthogonal to the first direction so that the first display element and the second display element are arranged alternately in the second direction.

12. The apparatus according to claim 11, wherein the first display element, the second display element and the third display element emit the lights of different colors among three colors of green, red and blue.

13. The apparatus according to claim 1, wherein K is equal to 4, and each of 4 filters defines performing the filter process on the basis of different pixel among the pixels in 2 rows and 2 columns corresponding to display elements on the display device.

14. An image display method for displaying an image on a dot matrix type display device having a plurality of display elements each emitting single light, comprising:
inputting an input image having pixels each including one or more color components;
extracting a feature of the input image;
generating K subfield images by performing a filter process using K filters for the input image of one frame;
setting a display order of the K subfield images based on the feature of the input image; and
displaying the K subfield images in accordance with the display order on the display device in one frame period of the input image.
